(19) United States
(12) Patent Application Publication
(10) Pub. No.: US 2013/0346172 A1
(43) Pub. Date: Dec. 26, 2013

(54) METHOD AND SYSTEM FOR VALUING AND REWARDING THIRD PARTY MARKETING OF PRODUCTS VIA A SOCIAL NETWORK

(71) Applicant: Jonathan Wu, New York, NY (US)

(72) Inventor: Jonathan Wu, New York, NY (US)

(73) Assignee: ECHOED, INC., Great Neck, NY (US)

(21) Appl. No.: 13/533,642

(22) Filed: Jun. 26, 2012

(51) Int. Cl. G06Q 30/02

(52) U.S. Cl. 705/14.16

(57) ABSTRACT

The principles of the present invention relate to methods and systems for marketing products by prompting customers to identify purchased items to be shared through their social networks and displaying links on the customer's social networking sites, thereby promoting particular products to members of their social networks, which may then propagate through other parties' social networks, where the amount of social activity generated by the sharing of interest in the products is tracked and scored, and the original customer can receive a portion of their purchase cost credited back as a reward.

### FIELD OF THE INVENTION

This invention relates to the field of promotion and marketing of merchandise via a communications network and, in certain embodiments, to compensating the word-of-mouth marketing propagating through social networking by crediting back an amount of an item's purchase price.

### BACKGROUND OF THE INVENTION

Retailers, wholesalers, manufactures, importers and other commercial entities have sought various methods and channels for advertising, promoting, and marketing their products and services. Previous advertising and marketing efforts typically took the form of direct advertising or marketing by the actual seller to an intended buyer using an e-commerce website, through which a potential customer could view images and read descriptions of products. Other users of the website were permitted to leave feedback regarding particular items that were purchased on the website, but such comments were of little value due to a lack of knowledge about their source. The expansion of the Internet and development of online social networking has created a myriad of additional opportunities for vendors and suppliers to reach out to customers, expand their existing markets, and develop new markets.

### SUMMARY OF THE INVENTION

The general principles of the presently claimed invention relate to a method and system for individuals or groups to share their interest in or endorsement of purchased products with others within their social network, and valuing the extent of such sharing to determine an amount of reimbursement for the originating individuals or groups.

One or more of the non-limiting embodiments relate to a computer-implemented method of incentivizing word-of-mouth marketing through social networks, which comprises prompting a purchaser to register as a social-network marketer; registering a purchaser as a network marketing system user, which involves requesting the purchaser to provide personal identifying information for registration, identifying which social networks the purchaser is a member of, where the purchaser can identify their membership in a social network by checking boxes for each social network they wish to register, receiving the marketing system user's personal identifying information, and storing the marketing system user's personal identifying information and identified social networks on the network marketing system.

In some embodiments, the method further comprises prompting the marketing system user to identify which purchased item(s) will be shared through their social networks, receiving an indication of which purchased item(s) will be shared, associating the identified purchase items with the user's personal identification information, and storing product information for the identified purchased item on the marketing system, creating a link with a unique URL address related to each of the shared item(s), wherein the URL address associates the system user with the shared item(s), and displaying the link(s) on the system user's social networking sites. Third-parties can click on the link and be redirected to either a different website where the third party can purchase the item or to the marketing system, and wherein the word-of-mouth marketing activity can be tracked through the unique URL address, wherein tracking can be accomplished by placing a cookie on a third-party's device or computer system.

In addition, some embodiments provide for a vendor to pass information that uniquely identifies a purchased product to a marketing server each time a product is purchased from that vendor. The network marketing system may then generate a unique identifier for that product, wherein the unique identifier may be used by the user when sharing the product to identify both the product and its connection to the particular user. The unique identifier may be a unique URL.

Embodiments of the invention also relate to establishing a threshold level of marketing activity to be reached before compensating the marketing system user for their word-of-mouth social network marketing, and crediting a portion of the system user's original purchase price back to the user when the threshold level of activity has been reached. The activity of the word-of-mouth marketing can be tracked, for example, based upon the number of times a unique link related to the item is clicked, the amount of third-party comments relating to the item, the number of Likes relating to the item, and/or the number of re-tweets incorporating the unique URL related to the item.

Another embodiment can include valuing the extent of marketing by a system user by determining the number of different third parties that click through the unique URL, which can be determined, for example, by placing cookies on each party's system when they are redirected to the website offering the associated item, storing on the network marketing system the cost of the item being shared, and calculating a weighted value for the marketing activity based upon the cost of the item and the actual extent of the word-of-mouth marketing activity, wherein the weighted value is used to determine if the established threshold level has been reached. The amount, which may be a portion of the purchase price, credited back to the user can be applied as a rebate to the user's original form of payment (e.g., credit card, debit card, gift card, bank account, electronic clearing house, etc.), and the portion credited back can be a predetermined percentage of the original price of the shared item.

Furthermore, in some embodiments a vendor sales system may send a uniquely identifiable order number or purchase number to the network marketing system server to allow the marketing system to relate any linking, clicks, and/or social activity corresponding to a purchase or payment transaction with the purchased item and user.

An embodiment of the presently claimed invention can also relate to placing identified purchase items in a gallery on the user's social network that can be browsed by third-parties, wherein the gallery includes at least an image of the item being shared and user's comments associated with the shared item. In some embodiments, the marketing system server(s) may create and place such image and description content of a user's social network through an application program interface (API), wherein the content included a unique link for the identified item.

Non-limiting embodiments of the invention relate to a computer-implemented method of valuing word-of-mouth marketing through social networks, which comprises registering an individual with a word-of-mouth marketing system as a marketing system user, creating an account for a registered marketing system user, requesting the registered marketing system user to identify the social networks with whom they have an account, storing a list of identified social networks in a database, creating a link with a unique URL address associated with the user, providing the link to the user, where the link can be posted on a social network webpage or inserted into an e-mail, tweet, response, or other form of message. The embodiment may also comprise importing the registered marketing system user's social network connections from the identified social networks, wherein the social network connections are members of the user's social network, determining the number of third-party members a registered marketing system user has in their social connections, storing the user's social connections in a computer system's memory, mapping the relationships between the user's imported social connections to form a linked set of nodes for tracking the propagation of a social referral through the user's social connections, wherein a node represents one members of the user's social network. The embodiment can also comprise identifying the type of social referral propagated between the linked nodes of the map, wherein the referral type can be a comment, a Like, a forwarded link with the unique URL, or a re-tweet with the URL embedded in it, etc., and tracking the number of referrals passed between nodes of the map, tracking the number of times the link with the unique URL is clicked by one of the members of the user's social network. Some embodiments can relate to determining a relative weight factor for each type of referral and each click on the URL, and calculating a total weighted value representing the amount of social activity that is generated by the market system user, wherein the weighted value is calculated by summing the number of referrals of each type multiplied by their weight factor with the number of clicks by members of the user's social network.

An embodiment can also comprise placing a tracking cookie on each device of each member of the user's social network that is utilized to click on the link, and track the distribution of exposure through the user's social network, mapping the progression of shares through the marketing system user's social networks to determine the propensity of the user's network connections to rebroadcast the user's initial sharing of a purchased item, and utilizing the extent of rebroadcasting for a particular item to identify higher valued networks.

Another embodiment relates to determining the value of the system user's network to the marketing system from the size of the identified social network(s), wherein the size is based on the number of connections, and the amount of influence the system user has over the connections, as indicated by the percentage of connections that purchased a previously shared item, to determine the probability that a number of sales shall be made through sharing on the user's network, and informing the vendor to retroactively credit a portion of the system user's original purchase price back to the user's original payment form based upon the actual number of sales or amount of activity meeting or exceeding the determined value.

Other non-limiting embodiments of the present invention relate to a computer system for promoting word-of-mouth marketing over social networks, which comprises a server system comprising non-transient computer readable storage and at least one processor for running at least an application program and a database program; an application program running on the server system, wherein the application program comprises a communication function that is configured to connect a vendor's sales system to a word-of-mouth marketing system server over a communication network, an interface function communicating between the vendor's sales system and the marketing server system, wherein the interface is configured to allow the marketing server system to prompt a purchaser interacting with the vendor's sales system to create an account with the marketing server system, identify one or more social network(s) with which the purchaser has an account, and select one or more items to be shared on the identified social networks from a set of one or more item(s) purchased by the purchaser at a particular sales price.

Embodiments of the invention can also include a URL assignment function that is configured to create a new, unique URL, wherein the URL relates the item to be shared with the registered user, a database program running on the marketing server system that is configured to store information relating to at least a specific user's identification information, a set of social connections, a set of purchased items, and product information for a purchased item selected to be shared on a social network, a cookie tracking function running on the server system that is configured to place a tracking cookie on a third-party's electronic device when the third party clicks on the unique URL relating to the shared item, and a monitoring function running on the server system that is configured to monitor the number of times the third party clicks on the URL for the shared item or determine if another third party has accessed a shared item through a secondary referral.

An embodiment of the invention can also comprise a reward function that establishes a threshold value for the number of times a shared item has been accessed through a link having the assigned unique URL or accessed through a secondary referral as indicated by the tracking cookies placed on third-party devices, and communicates to the vendor's sales system instruction to credit back to the purchaser a portion of the particular sales price when the established threshold has been exceeded.

An embodiment of the invention can also comprise a social network tracking function configured to monitor the marketing system user's purchases of items to determine the frequency of the user's purchases, the quantity of items purchased, and the amount spent on each purchase, store the frequency, quantity, and mount of each purchase made, and the specific product(s) purchased by the particular system user in the database file for the specific system user, identifying the type(s) of products that the system user purchases, wherein the product types are predetermined categories defined by the marketing system, identify the amount spent on products in each category, and determine the probability that the marketer will purchase another item within the same categories as previously purchased items from a different vendor. In some embodiments of the invention, the user interface is configured to provide a button for a purchaser to click to create a new account, one or more fields for the purchaser to enter their specific identification information, a predetermined list of social networks from which the purchaser can select one or more social networks, and a button for the purchaser to click to select one or more purchased item for sharing on the one or more selected social websites.

Other embodiments of the invention comprise assigning a value to the one or more shared item(s), wherein the value is calculated using the probability that a third party will eventually purchase the shared item and the price of the shared item.

An embodiment of the present invention relates to a system for stimulating word-of-mouth marketing efforts, which comprises a computer system running one or more applications. In such an embodiment, the computer system and/or application(s) can be configured to connect to one or more vendor's sale system, wherein a sales system can be an in-store point-of-sale system, an online ecommerce portal, and/or a mobile device application portal, and can create an account for a user who completes a purchase through a connected vendor's sales system. The embodiment can store information on the system about items selected by the user from a set of items purchased through the sales system, post the one or more selected items on the user's selected social networks with a unique URL link for each item that redirects a third party to the computer system, where the selected item is placed in an image gallery on the social network(s) that can be browsed by third-parties, and wherein the user can add textual comments regarding the selected item(s) to the post on the social network(s). The embodiment of the system can also measure the amount of activity on the user's social network related to the selected item(s), and reward the user for sharing the selected item with others on the user's social network by crediting an amount of the selected item's purchase price back to the user when the measured activity reaches or exceeds a predetermined amount.

In another embodiment, the amount of activity on the user's social network relating to a selected item comprises click-throughs on the related item link, comments, Likes, +1s, Responses, and Re-tweets, and wherein the user receives a credit or rebate applied to the original form of payment used to purchase the selected item.

An embodiment of the presently claimed invention relates to non-transitory computer readable storage medium having computer-readable instructions executable by a computer processing system stored thereon, where the computer-readable instructions cause the computer system to register a person as a word-of-mouth marketer, store information personal to the marketer on the system once they register with the system, and request them to identify one or more social networks with whom they have an active account(s). The computer-readable instructions can cause the computer system to store a list of items purchased by the marketer for future selection, as items the marketer may like to share with persons on their social network(s), and request the marketer to select one or more items to be shared over the marketer's identified social networks from the list of purchased item. The instructions can cause the computer system to post the selected items on the social network websites, and thereby share the selected item(s) over the marketer's identified social networks.

The computer-readable instructions can cause the computer system to monitor the amount of activity resulting from the sharing of the selected item(s) on the marketer's social network(s), and reward a marketer by informing a vendor that a portion of a purchase price for the item should be retroactively credited back to the marketer.

The computer-readable instructions can also cause the computer system to import a list of social connections from the one or more social network(s) identified by the marketer, and calculate a value for the marketer's imported social connections using the number of social connections and the amount of activity on the social network relating to the shared item.

Other non-limiting embodiments of the present invention relate to non-transient computer readable medium comprising instructions for implementing the various method steps and system functions described herein.

A person of ordinary skill in the art will recognize that these are only some particular non-limiting embodiments and examples of the presently claimed invention, and that the order of such described steps and operations may be rearranged or combined in different manners that are intended to be within the scope of the presently claimed invention. A person of ordinary skill will also recognize that the various steps and operations can be implemented and executed using different combinations and arrangements of hardware, software, and firmware that are also intended to be within the scope of the presently claimed invention.

### BRIEF DESCRIPTION OF THE DRAWINGS

The above features and other advantages of the various embodiments of the present invention will become better understood by reference to the following non-limiting illustrated examples depicted in the accompanying drawings wherein:

FIG. 1 is a depiction of the inventive process in accordance with one exemplary embodiment of the invention.

FIG. 2 illustrates an example of an initial step of the process shown in FIG. 1.

FIG. 3 illustrates an example of a second step of the process shown in FIG. 1.

FIG. 4 illustrates an example of a subsequent step of the process shown in FIG. 1.

FIG. 5 illustrates an example of an evaluation step of the process shown in FIG. 1.

FIG. 6 illustrates an example of scoring metrics in accordance with one embodiment of the invention.

FIG. 7 illustrates another example of scoring metrics in accordance with an embodiment of the invention.

FIG. 8 illustrates an example of a credit or reward step of the process in accordance with an embodiment of the invention.

FIG. 9 depicts a flow chart for an embodiment of the claimed invention showing possible steps of a method.

FIG. 10 illustrates an embodiment of the network marketing system.

FIG. 11 a flow chart for an embodiment of the claimed invention showing possible steps of a method.

FIG. 12 is depicts the steps of another embodiment of the claimed invention.

FIG. 13 illustrates an example of a product image and associated URL link.

The same reference number refers to the same part in each of the different drawings. Furthermore, the figures are intended to illustrate various non-limiting examples and embodiments of the presently claimed invention, and are not intended to limit the scope of the claimed invention.

### DETAILED DESCRIPTION OF THE INVENTION

The principles of the presently claimed invention relate to providing incentives to customers for promoting various products by their word of mouth over communication networks, wherein a communication network may be, for example, the Internet, the World Wide Web, user group networks, WANs, LANs, or other interconnected wired, wireless, fiber optic, and/or satellite communications systems used to transmit information between multiple users.

In some embodiments these customers promote particular products to members of their social networks, which promotions may then propagate to other individuals through those members' social networks. Social media and networking sites provide additional hubs for the collection of endorsements and channels for the dissemination of such advertisement and promotion to individuals who may give greater credence to such endorsements and recommendations due to familiarity with the promoter on other social levels.

The principles of the presently claimed invention also relate to measuring the performance of a customer's product and/or service promotions by valuing or scoring the amount of social activity generated by the sharing of interest in the products and/or services from such purchasing-party promotional sources, the successfulness of the product promotion, and the extent of market development and penetration of the promotions. In some embodiments, the performance can be measured and gauged by the number of clicks on links having a URL with a unique identifier, information collected with cookies, and/or increased sales.

The principles of the presently claimed invention also relate to the collection of social activity data and marketing metrics to identify responsive markets, and further improve advertising and marketing approaches to reach a greater number of potential customers and improve sales.

The principles of the presently claimed invention also relate to retroactively compensating a vendor's customer that purchased a product or service and registered as a marketing system user, through crediting back a portion of the purchaser's initial payment for the expansion and penetration into the customer's social network. Compensation can be determined, for example, based upon the number of clicks, comments, hits, Likes, +1s, re-tweets, etc., on or related to the product or service through connected links, or the subsequent sales of the item through channels directly or indirectly associated with the purchaser's online social presence. The credit may be applied retroactively to the original purchaser's original form of payment, for example their credit card bill, some time after the initial measuring period commences. In some embodiments, the compensation may be done automatically by the network marketing system via an application interface installed on a vendor's computer system or server.

The principles of the presently claimed invention also relate to incentivizing marketers and tracking metrics to increase brand awareness through providing a rebate to the purchaser for the exposure of the product to their social network. The purchaser may provide feedback on their purchases by posting comments on their social networking sites, sending tweets regarding the purchased items, or submitting likes or +1s for the item.

In embodiments of the invention a vendor's customer purchases items via the vendor's sales system. This purchaser may be prompted by the marketing system to register as a marketing system user at the time of the sale. A purchaser that registers as a user of the marketing system may be asked to select one or more of their purchased items to be displayed on the user's social networking site(s). The user may be prompted to identify their social networks. The registered user may be prompted to share one or more of their purchased items each time they make a purchase at a vendor connected to the marketing system. If the purchased items are selected to be displayed and shared on the user's social network(s), the user could qualify to receive a rebate on the cost of the original purchased item, which could be a product or service. When the activity associated with the shared item reaches a predetermined threshold, the user may receive a credit back on their purchase. A user could also receive other forms of rebates or credits.

Some of the non-limiting embodiments of the marketing and reward system comprise at least one system user completing a purchase from a vendor wherein the purchase can be made through an e-commerce portal such as an online website, an in-store point-of-sale system, such as an electronic cash register or terminal, an application running on a mobile device, or other purchasing systems that a user may interact with.

In one non-limiting embodiment of the present invention, once a purchase is made it is registered within the system and the user is presented with the option to share the purchased product or service with other parties through their social networks, such as Facebook®, Twitter®, LinkedIn®, Four Square®, Weibo®, RENREN®, BEBO®, Biip.no, and Google+®, as well as many other social networking platforms known to those in the art.

The system user can choose to share the purchased item by clicking a button, selecting a share option, or marking a check box for each individual item. The items can be presented to the user on a web page, or through a pop-up that lists a name and description, and/or shows an image of each item available for the user to pick from. The user can be prompted to provide a brief narrative about each selected item, or be provided with predetermined lists identifying the typical pros and cons of the item. The different predetermined lists can be made available for either a product purchase/item and a service purchase/item (e.g., arrived in good/working order, finished task within reasonable time, etc.). Once completed, the profile for the purchased item may then be shared in a manner more fully described below.

In some embodiments, each time a product is purchased through a vendor's sales system, the vendor system passes information to the marketing system to uniquely identify the order and the purchased product. The marketing system then generates a unique ID for that product. When the user chooses to share that product, the marketing system creates a unique link, which may be based on the unique product ID and unique user ID, or associated with the product and user through a stored correlation table. The marketing system application server then looks up the user's list of social networks authentication credentials, confirms authorization of the user, connects to the social network via the social networks' published APIs, and creates the link on the social network.

In a non-limiting embodiment, the marketing system stores and shares the user's and vendor's profile information about the selected purchased items on the social networks by either inserting or appending the selected information to the user's social network page, or creating a new page that is linked to the user's social networking account, as would be known to a person of ordinary skill in the art. The item(s) and comment(s) and/or summary may be placed on the social network(s) as, for example, posts, news feeds, or items with a link/URL that redirects a third party through the system. The marketing system captures the profile information for the item(s) and may place them in a permanent gallery that can be browsed by other parties on the social network(s) by either going to the user's social web page(s), choosing to follow the user's tweets, or otherwise associating themselves with the user, as determined by the technical/administrative requirements of the particular social network. The system can track and measure the activity on the different networks based upon click-throughs on the link, comments, tweets or retweets, likes, +1s, responses, etc., added or sent by third parties on the particular social network.

The link provided on the purchaser's social network page contains a URL that is uniquely coded to that purchaser and the selected item, so that when a third party clicks on the link to be redirected to a webpage relating to the item the web server can recognize the particular link URL and post the event to the original purchasers profile/account. The number of click-throughs on that link can be tracked and the purchaser credited for the amount of social activity generated by that shared item. Similarly, if the particularly coded link is pasted into an email or otherwise distributed to third parties, and those third parties use that link to access the a webpage related to item, the original purchaser would also be credited for that activity. Such coded information can also be provided in tweets by embedding the URL in the tweet itself in order to track activity related to the shared item.

The marketing system assigns the uniquely coded URLs to the registered purchasers when they elect to share a purchased item through their social networks. Each selected item has its own unique URL. The URL redirects the third party through the marketing system to the actual product, where the product can be on a vendor's or retailer's website, or on the marketing system's website.

Embodiments of the marketing system can measure the traffic generated through the URL and credit the purchaser for the amount of activity that they have generated. The marketing system determines how to weigh the different types of activity, which is then used to determine the value of the sharing and social activity. Activity can comprise, for example, comments, Likes, +1s, responses, re-tweets, and clicks, and each type of activity can be weighted differently to account for its different marketing value compared to the other types. An algorithm calculates the value based upon the amount of weighted activity and determines whether the value surpasses a vendor-set threshold for the purchased to receive a credit towards their initial purchase price. In other cases, the marketing system can set the threshold value.

The coordinated use of cookies with a URL can be used to follow threads of viewership, and monitor how subsequent re-sharing of the customer's information relating to the purchased item, e.g., by third-party re-sharing in accordance with the present invention, cause the marketing network to grow. A cookie can be placed on each device that accesses a shared item through the link URL.

A database is used to compile the system users' profiles and keep track of each user's selected items, as well as the number of times each of the uniquely coded URLs have been activated. The database can include a record for each user and fields for the registered purchaser's name, address, social networks that they belong to, a list of items that they have purchased, a list of items they have selected to share, which comprises a sub-set of their list of purchased items, and a counter associated with each selected item, where the counter keeps track of the number of times the URL assigned to a selected item has been activated. The database can also include purchaser and product information such as a user ID, a product ID, a product name, a product description, an order number, the brand, a category or classification, the price, the date of the sale, a user e-mail, a web address or URL to link to the item, a link to an image of the product, etc.

Embodiments of the presently claimed invention also include methods and systems for aggregating and importing the list of members of the customer's social networks (social network connections) from their registered networks. This serves to identify who each user is connected to and the potential reach of any shared purchase/product. The social network connections are members of the user's social network, and the number of third-party members a registered marketing system user has in their social connections can be determined and the user's social connections stored in a computer system's memory associated with the marketing system. The relationships between the user's imported social network connections can be mapped to form a linked set of nodes for tracking the propagation of the shared information about the purchased item (such as a promotion or endorsement) by and among the members of the customer's social network, where each node represents one members of the user's social network. Cookie places on each members' device(s) can be used to identify who is part of a particular social network, and whether the member has accessed a link URL or provided a comment, Like, re-tweet, etc., for a shared item.

By keeping track of the number of times a particular URL has been clicked, the marketing system and thereby the vendor of the selected item can monitor how well each share has performed. The marketing system can perform audits of the marketing system user database records, and identify metrics such as the purchaser's social network size, how the item was recommended, and identify the recommend language associated with the item. The marketing system can analyze this information and correlate it with amount of activity generated by the associated URL to determine what the spending drivers are and who is driving the most product activity and sales. The different factors affecting the product activity can be identified, for example, from the profile information and the correlated product activity, and the most relevant factors identified from the overall set of factors. The information can be used to map the demographics of the purchasers and the social networks to identify and refine the product market and the marketing initiatives. This information can be monetized and provided back to the product vendors and retailers, as packaged demographic and promotional information.

The purchased items that the purchaser has selected to share are posted to the selected social media web pages using an application program interface (API), which hook into the social network. The shared items can appear as posts or news feed items with a link and the assigned URL. The URL redirects a third party that clicks on the link through the marketing system, which captures the event in the database. The API programming used to hook into the social websites are known to persons of ordinary skill in the art. The interfaces for the social networks may be created, for example, using API development tools such as Facebook® Connect and Twitter® Connect to create the connection applications.

In some embodiments, the system values the activity based upon the strength of the immediate network, the value of the user's purchased or vendor's sold item, the increase in activity associated with the item due to the user's linking, tweeting, etc., the increase in the number of new third parties visiting the item/link, and/or the relevance of the item to the immediate social network.

As a non-limiting example of an embodiment, an individual with a Facebook® page who is an avid runner and has a number of third parties he associates with due to their interest in running may purchase the newest running shoe from a vendor. The purchase is registered in the system and the user is given the option to share his purchase with his social network by displaying the item somewhere on his Facebook® pages by selecting the registered item. Once the running shoes are selected, the user is prompted to provide comments regarding the item, which are also displayed on the webpage. The third parties can now choose to browse the item by clicking on the link added to the Facebook® page. When a third party uses the link to go to the item, the web server can determine both where the party linked from, and whether the party has visited the item page before, for example by checking cookies on the third-party's device or entries in a database. If the third party is new to the page, the system can register the party and the user the party is associated with. By building up a log of similar activity from the user's link, the marketing system can determine the relevance of the item to that particular social network by the number of new visits by new parties through that link within a specific time period, and the overall amount of activity by the total number of click-throughs from that link by both new and repeat visitors. The breadth of activity can be determined by the relationship of new and repeat viewers relative to the user.

In some embodiments, the marketing system rewards the user based upon the valuation of the different metrics used to measure the response to the user's marketing. The reward can be a credit or rebate back to the user for a portion of the original purchase price of the item. Such rewards can be provided to the user through the original payment processor (e.g., PaypPal®, credit card company, debit card, bank, etc.), as known to those in the art of ecommerce, credit, and banking. The vendor benefits from the results-oriented marketing and advertising, as well as the generation of additional market data from the user. The user is compensated for the advertising and marketing efforts, and the generation of marketing data.

In some embodiments, the reward is only based on the amount of activity generated by a marketing system user for the first week after they elect to share an item. This helps to reduce the complexity, storage requirements, and processing resources necessary to keep track of each user's rewards, and incentivizes the user to provide their effort early in the sharing process. In other embodiments, the system may continue to monitor the user's activity and provide the reward when the user's activity reaches the threshold value.

In an embodiment, the system integrates into various types of vendor sales systems (e.g., ecommerce, Point-of-sale, mobile applications) by installing an interface with the vendor's system that identifies the user and the items in the user's associated sale, and stores the data in the marketing system database. The vendor plugs into the marketing system by calling an interface with the marketing system to request an action button and providing parameters for the products that currently have been purchased. Such order information can include: a user ID, an order ID, a product ID, a Product name, a product description, the product brand, a product category, a product price, a sales date, a web address for the product, an image address for the product, etc. If the purchaser clicks on the share button, the user is given the option of logging into their marketing system account or to create a new account with the system. The accounts are created via a social network API (e.g., Facebook Connect, Twitter Login, Google+ Login, etc.). The purchaser can attach multiple social network accounts to their marketing system account. Once they are logged in, the purchaser can identify an item as being shared. The identified item can be entered into the appropriate field of the marketing system database.

In some embodiments, the vendor sales system sends with each payment transaction an internally identifiable order number when an order is made on the vendor sales system. This same order number is also passed to the marketing system application server so that any links, clicks, or social activity can then be linked to the particular order. After generating an activity list of purchases, the marketing system server sends the vendor sales system the orders to be credited. The vendor sales system then requests a list of transactions from the payment processor. The vendor sales system then looks through the received transactions to find the transactions with the assigned order numbers, wherein the order number is a custom ID. (Since most system will not allow you to use them to look up transactions). The refunds are then made via the API of the payment processor via the installed plugin.

In an embodiment utilizing an online ecommerce website and web pages, the vendor (i.e., retailer, wholesaler, manufacturer, etc.) can plug into the system by calling the interface to request an action button. The vendor can send the data required by the system, which was generated at the time of sale, for the product(s) that were bought by the user. The action button allows the user to log into their account or create an account if they do not have one. Accounts with the system are created through the various social network application program interfaces (APIs), such as Facebook Connect, Twitter login, Google+ login, etc. Users may attach multiple social network accounts to their marketing system profile. A purchaser can also toggle the social networks they have available on or off, and customize the message for each network.

Once a user has logged into the system, they are able to share their products and purchases with others online. Each user is able to toggle which social networks they will share their products with on and off. Each user can also customize their comments associated with each item for each of the different social networks they have toggled ‘on’ for the particular item. Specifically, a text box can be provided for each identified social network that is activated to allow a user to associate specific comments with each item for the particular network. A window can be provided to show the user the minimum and maximum percentages of what is available.

If a user chooses to share a product, the system captures the user and product information, and stores the information on the marketing system, where such data can be stored in a database, as would be known in the art. The information can include the purchase data described above as well as a name and/or ID associated with the social network on which the item and information will be shared.

Additional data relating to a user's social connections can be imported to the system to identify who each user is connected to and their relationship with the user. This additional information can be used to initially determine the extent of a user's social network and the immediate reach of a user's marketing efforts for shared items.

Additional information regarding the extent and interconnection of the user's network by crawling the user's social links, and identifying connections such as through “friends”, “circles”, etc. The social connections between a user and third parties obtained by the system from importing the user's connections and crawling may be stored in a database and analyzed to create a map of linked nodes between the members of the social network. The system can then determine a path between two or more members of a network, and particularly between a user and a third party viewing a product.

Tracking cookies may be placed on the user's and third parties' systems that are used to click-through a share link on the user's profile. The cookies can identify a new visitor to the user's profile, a first time click-through on the product link, and secondary referrals in conjunction with the user's network data and map to track the cumulative repetition and exposure of a shared item.

The crawler can also determine the activity attributed to a shared product or service by crawling the user's social network and aggregating the comments, responses, likes, etc, relating to the product. This activity data can then be reported back to the system and used to determine a user's compensation and the penetration of the marketing.

Coordination of social activity with the third party's profiles can also be used to determine the demographics of the social network and the product placement.

The system can calculate the general value of the sharing based upon the original purchase price of the item and the amount and extent of activity generated within the user's social network. The system can gather the social network and activity information through the user's social connection data, data obtained by crawling the user's connections, and the gathering of information from cookies and click counts on the user's item links.

The value of the share can be calculated by weighting each of the activity data parameters (i.e., click-throughs, comments, tweets and retweets, etc.) obtained from the user's profile link and each of the third parties that are part of the user's social connections. The sum of the weighted amounts provides a generalized value of that user's marketing and determines the amount of a reward received by that user.

In another embodiment, the system can also track the registration of a new user after they have purchased the item shared by the original user. In this manner, activity data can be collected from both the original user and the new user, and compared to determine which user has the stronger social network, and which comments, likes tweets, etc., generate more activity. Such additional data could be used by a vendor or advertiser to adjust their own marketing and/or advertising approach to use the wording, presentation, or demographic information to be more inline with the better online activity generating material. For example, a new user may provide better worded endorsement language than the original user/poster and thereby generate greater click-though to the product than the original user. While the new user will garner more rewards, the vendor or advertiser will also be made aware of the better language in the new user's comments or tweets.

The user can receive the calculated reward as a credit on their original purchase through the electronic payment method or payment processor (e.g., credit card company, Paypal, bank transfer, etc.) used for the original purchase, or by a mailed rebate check, particularly if the payment for the original purchase was by cash or check at a point-of-sale or payment voucher sent with an invoice.

In some embodiments involving vendor sales systems lacking an automated mechanism or API for refunding orders, the marketing system provides an application plug-in (i.e., software) that is stored and run on the vendor's server system(s), so that the marketing system would not be required to receive a user's payment authorization credentials, for security and privacy issues, for the vendor or the payment transaction IDs.

Examples of different embodiments of each of the various components as well as different embodiments of the overall marketing system will now be described in more detail with reference to the figures. It should be understood that these drawings only illustrate some of the possible embodiments, and do not represent the full scope of the present invention for which reference should be made to the accompanying claims.

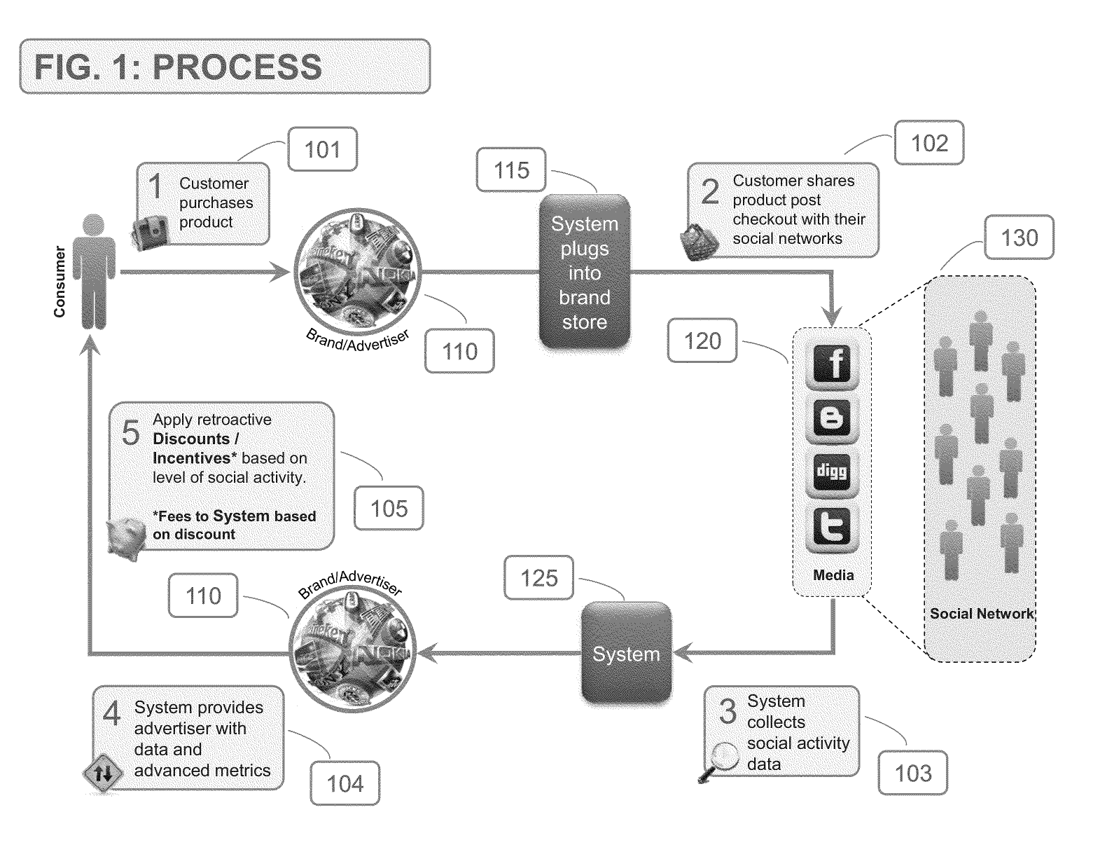

FIG. 1 illustrates a first non-limiting embodiment of the invention depicting the overall sharing and reward process. In a non-limiting example of the embodiment, the process is initiated at step 101 by a customer purchasing a product from a registered vendor 110 running the system's program interface 115. The user generates a trigger by the purchase, which is sent by the vendor to the system. The system 125 acknowledges the trigger and prompts the API to provide the user with an interface. If the user is not registered with the system 125, the interface requests registration information and sends the information back to the system to create a new user account. When the user has an active account, the API prompts the user for input regarding whether they wish to share their new purchase on a social network. If the user elects to share the particular purchase, they can select from a list 120 which social networks they wish to share the purchase on. The purchased item will then appear on their selected social networking sites and be visible to third parties 130 as determined by the user's privacy settings and the network's rules and programming. The system 125 collects the social connection data from the user's selected social networks and stores the data in the system's database(s). The system 125 can collect additional data by crawling the user's social network connections and establishing a social map. Information regarding the social activity surrounding the shared item is also collected to determine the breadth and depth of the product marketing. The collected network and activity data is provided to the vendor or intermediate advertiser registered with the system. A general value calculated based on the share activity can also be sent to the vendor/advertiser to determine the amount and method of reward to the user. The vendor can then apply the credit or rebate to the user's account and mail a check or adjust an electronic charge accordingly. The vendor also pays a fee back to the system for the network and activity data and to compensate for the programming interface provided by the system.

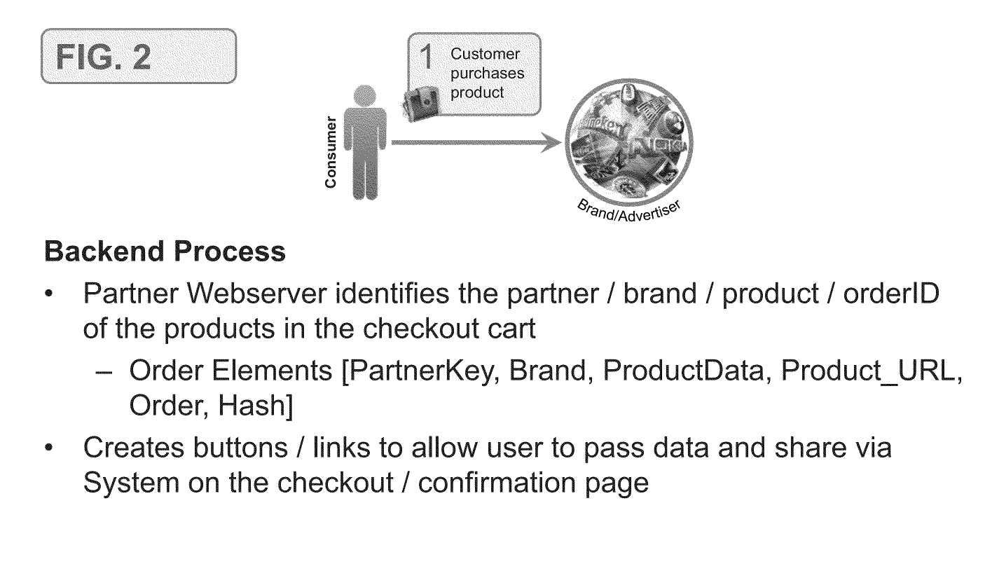

FIG. 2 illustrates an embodiment of the backend process of step 101 involved in triggering of the system by a purchase and the prompting of the user to share the purchased item. The vendor's web server identifies the vendor, the purchased item, the brand of the purchased item, the product URL, an associated hashtag, and communicates the product and order data to the system.

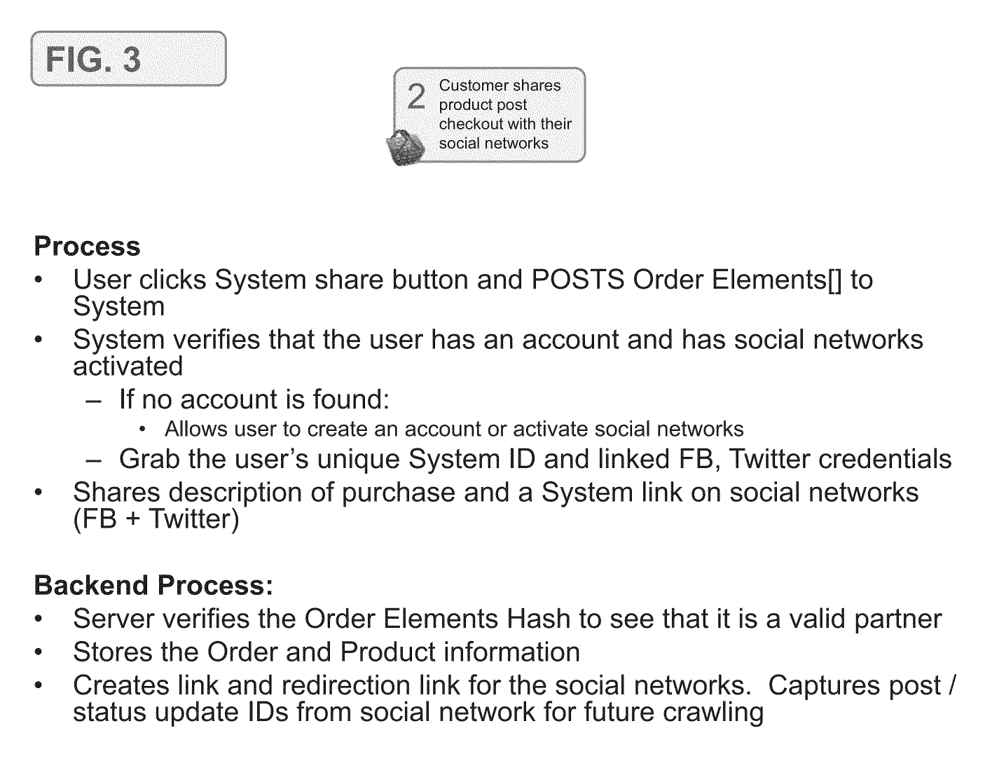

FIG. 3 illustrates step 102 in an embodiment of the process where the user elects to share a purchase with third parties by clicking on the system prompt share button. By clicking on the share button, the user alerts the system that that the user wishes to display the item on their social network webpage, tweet a comment with predetermined hashtags, or otherwise alert others to their purchase of an item or items. When the share button is clicked by the user, the vendor posts the purchase data to the system and

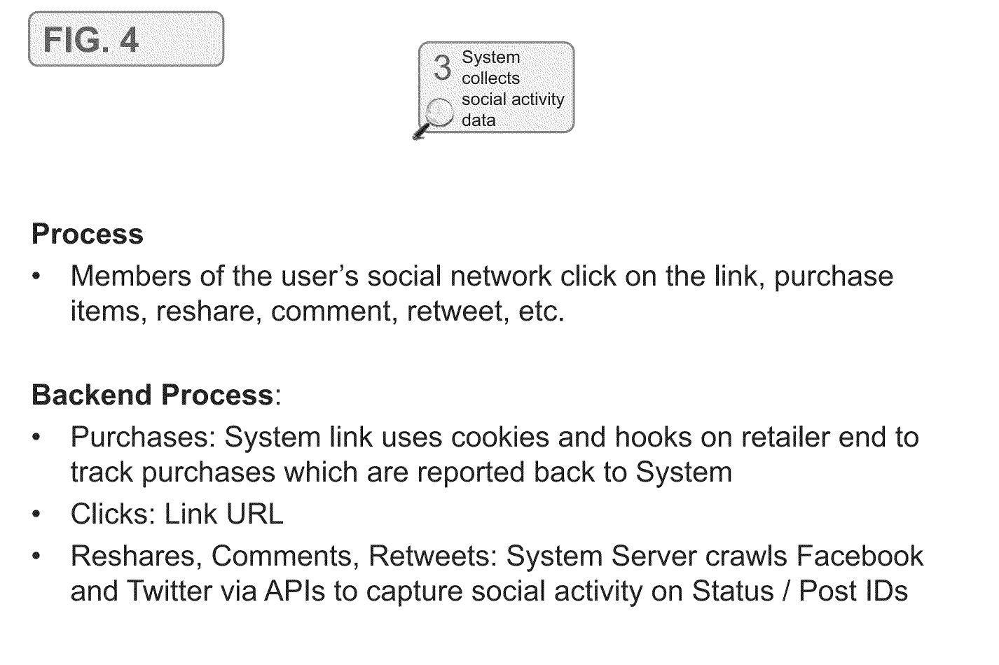

FIG. 4 further illustrates step 103 in an embodiment of the process where the marketing system back end creates links and uses cookies and hooks to the retailer/vendor end to track purchases, which are reported back to the marketing system. The links and cookies provide feedback to the marketing system computer or server regarding activity related to shared items.

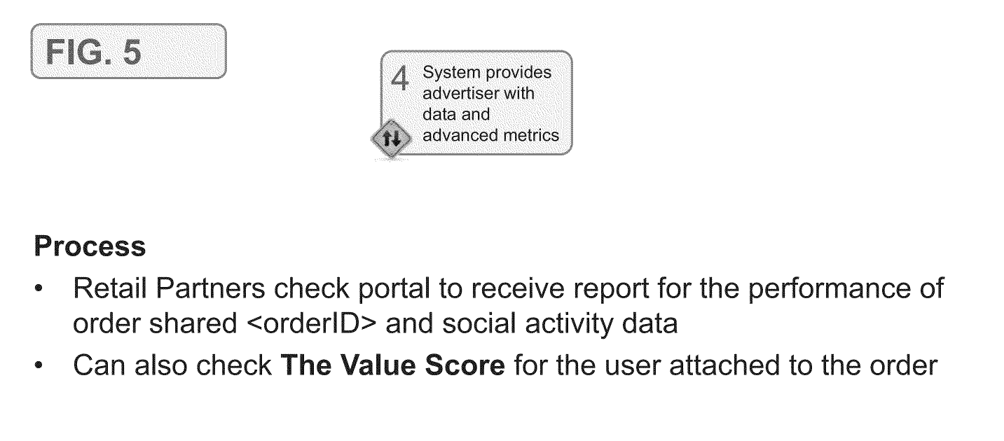

FIG. 5 illustrates step 104 in an embodiment of the process where the retail partners receive a report from the marketing system relating to the activity and performance of a shared item, as well as a value score for the user's social network(s), and other metrics.

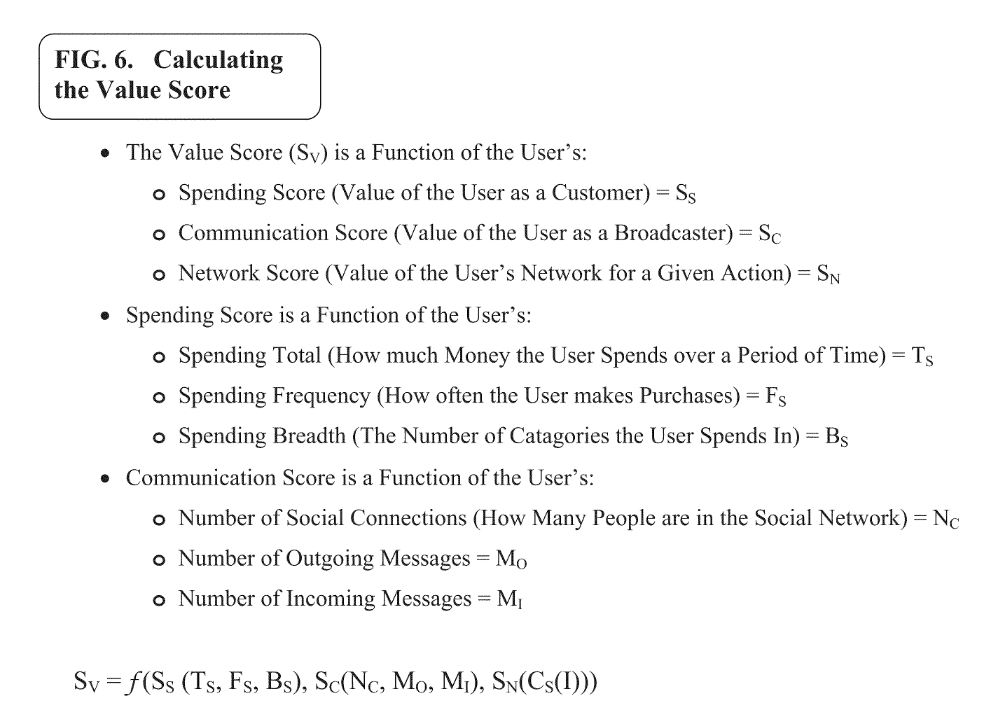

FIG. 6 illustrates an embodiment of the invention relating to the calculation of a user's value score based upon the user's spending, communication, and network value, where the spending score as a function of the total amount a user spends on purchasing items, the user's frequency of purchases, and the range of categories or classifications the user purchases items in. The communication score is based upon the size of the user's social network(s) (i.e., the number of members in each registered social network), the amount of outgoing marketing by the user, such as e-mails and tweet containing the unique link, and the amount of incoming messages from connections, such as comments, responses, like, etc.

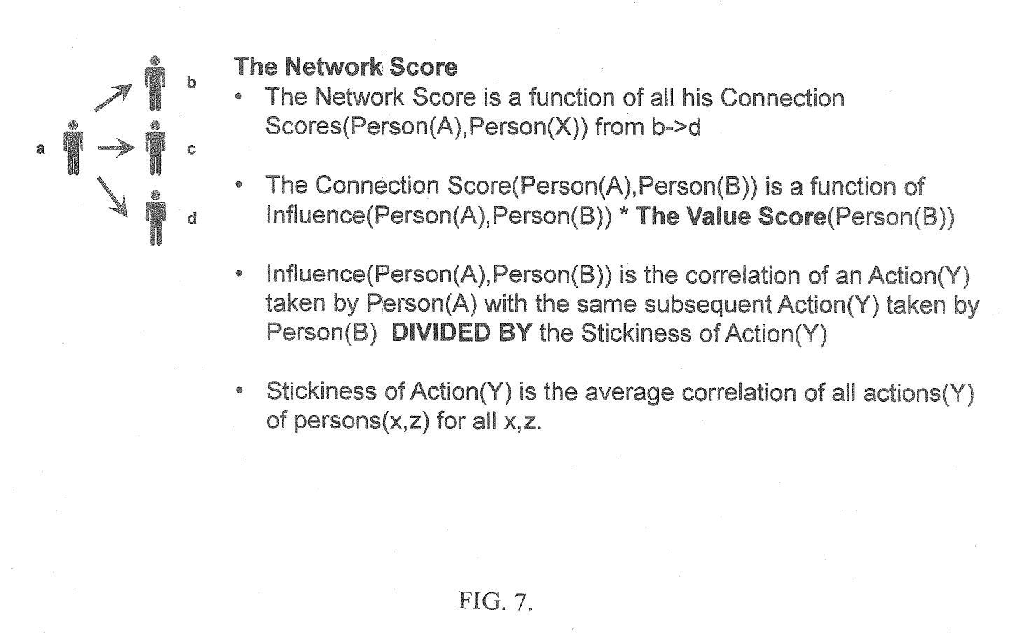

FIG. 7 illustrates an embodiment of the invention relating to the calculation of a user's network score based upon a users value score as well as additional factors. The network score is a function of a user's connection scores involving an ability to influence each member of a social network, and the average correlation of actions taken by the members of the user's social networks.

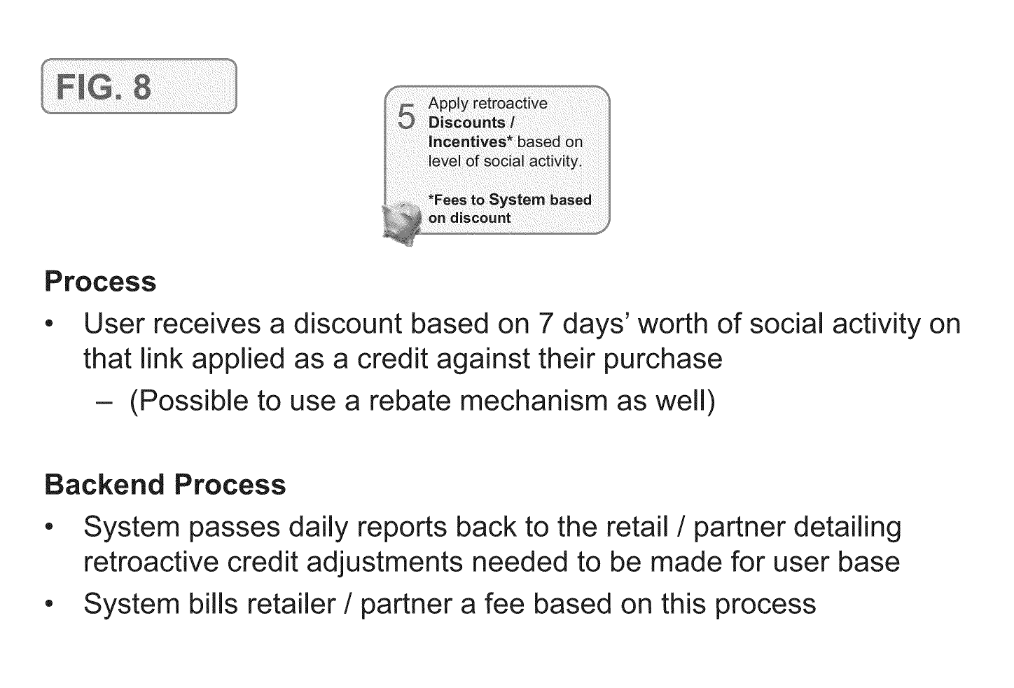

FIG. 8 illustrates step 105 in an embodiment of the process where the user receives a credit based upon seven days of monitored activity from a shared item, and particularly from the number of clicks on the link associated with the item. The marketing system can also provide information to the vendor/retailer indicating that a user should receive a retroactive credit adjustment on the user's initial purchase of the shared item, where the marketing system can collect a portion of the amount as a fee.

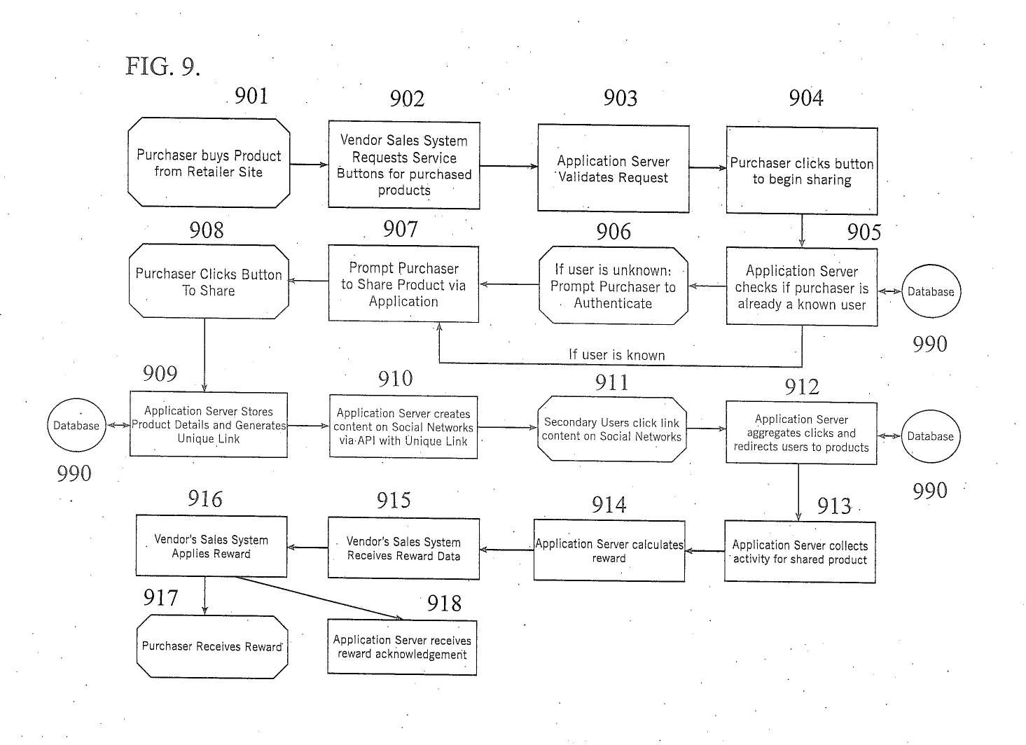

FIG. 9 is another non-limiting example of possible steps in an embodiment illustrating the process flow for application by a user, sharing of a purchased item, storage of information within a database, monitoring of activity, and rewarding of the user for the marketing activity. The exemplary process as illustrated begins at 901 with a purchase by a shopper of an item from a retailer using their website. The retailer or vendor sales system recognizes the online purchase as a triggering event and requests a service button from the marketing system for the purchased product(s) 902, wherein the request can be through an application program interface. The marketing system server receives the request from the vendor system over a communication channel such as a telephone communication system utilizing twisted copper pair wiring, coaxial cable, fiber optic cable, and/or wireless communications, as well as a packet switched communication network such as the Internet and World Wide Web, or any combination of communication channels, as would be known to those in the communications art. The marketing system server identifies the vendor and validates the request 903. A response is transmitted back to the vendor system, which provide the purchaser with an interface, such as a button and/or data entry field(s) for the purchaser to register with the marketing system and indicate to the marketing system server whether the purchaser would like to share the purchased item with others through the purchaser's social network(s). The purchasers response and information 904 is transmitted back to the marketing system server and the server checks a registration data base to determine whether the purchaser is already a known user registered 905 by checking the marketing system database 990. If the purchaser does not have a record in the data base 990, the marketing system server can prompt the purchaser 906 for personal identifying information needed to create a new record within the user database. If the purchaser had previously registered and is recognized as a user by the marketing system 907, the system server can acknowledge the user's request to share the purchased item 908 on any social networks indicated by the user. Product details are transmitted to the marketing system server over a communication channel and stored 909 on the database 990 within the user's record. The marketing system server generates a unique link to the shared item that correlates the shared item with the user so that clicks on the unique link can be detected and each time the unique link is clicked/triggered a field in the user's record can be updated. This allows the amount of social activity for an item associated with the particular user to be monitored and tracked over time and social networks. In step 910, the marketing system server creates content, which may include images, descriptions, and personal endorsements, for the previously selected social networks including the unique link and places the content on the social network(s) through an application program interface, as would be known in the art. The shared content can be displayed on social network web pages to allow viewing by third-parties, such as friends of the user, and present the unique embedded link to these third-parties. These third parties can browse the displayed content and click on the associated link 911. In step 912, the marketing system detects the triggering of the link, identifies the item and user associated with the unique link, and updates a counter field in the user's record within the database 990 to track the total number of clicks on that particular link. A separate field is created and stored in the users record to separately track the amount of social network activity for each shared item by the number of clicks on each unique link associated with the different item(s). The marketing system server monitors the individual fields 912 and identifies when a total number of clicks for a particular item reaches or exceeds a threshold amount to receive a reward 913. The marketing system server then calculates the user's reward 914. The reward data is transmitted to the vendor's sales system to notify the vendor that a purchaser has qualified for a reward 915. The vendor's system received the reward data and applies the reward to the user's account 916. The vendor's sales system credits the vendors account, and the user/purchaser receives the reward as a credit back on the original purchase 917. A separate notification is transmitted back to the marketing system server informing the marketing system that the user has received a reward 918. The marketing system can identify this reward notification by setting a flag in the user's record to indicate that credit has been given and that item/field should no longer be used to determine a reward (not shown). The particular item can now become dormant, or may be reset if the user purchases the same item again.

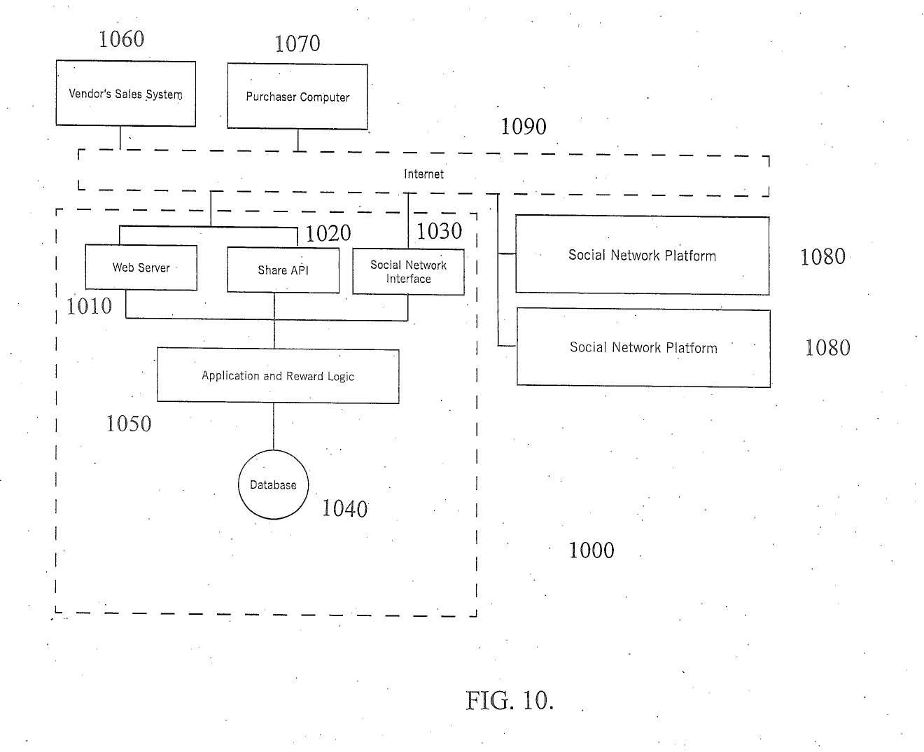

FIG. 10 illustrates an embodiment of the network marketing system 1000 comprising a server system, network interface, and a database, wherein the server may be one or more server systems or a virtual server system, and the database may be part of the server or a separate storage server in communication with a web server communicating through the network interface. In some embodiments, the server system comprises a web server 1010 for interacting with vendors, users, and third-parties through the Share Interface 1020, a front-end server for providing the social network interface 1030, and a database or storage server 1040 for storing and maintaining the various user records, vendor files, authorization and correlation tables, and social network lists. In other embodiments, the server system may comprise virtual servers performing each of the tasks running on one or more hardware systems. The marketing system includes all hardware necessary to implement the system, run the various software components, store all necessary data, and communicate with purchasers, vendors, users, and third-parties. The software can comprise the application and reward program 1050 that runs the marketing system, creates and updates user records, aggregates the clicks for the users, and interfaces with users, vendors, purchasers, social networks, and third parties. Specifically, a Share application program interface provides the screen displays, widgets, entry fields, and background programming that allows purchasers and vendors to interact with the marketing system, and a Social Network Interface 1030 provides interaction between the marketing system 1000 and all the social networks available through the marketing system. The Web Server 1010, Share API 1020, and Social Network Interface 1030 are connected to and communicate with vendors' sales systems 1060, users' computers 1070, and Social Networking Platforms and servers 1080 over various networks, for example the Internet 1090.

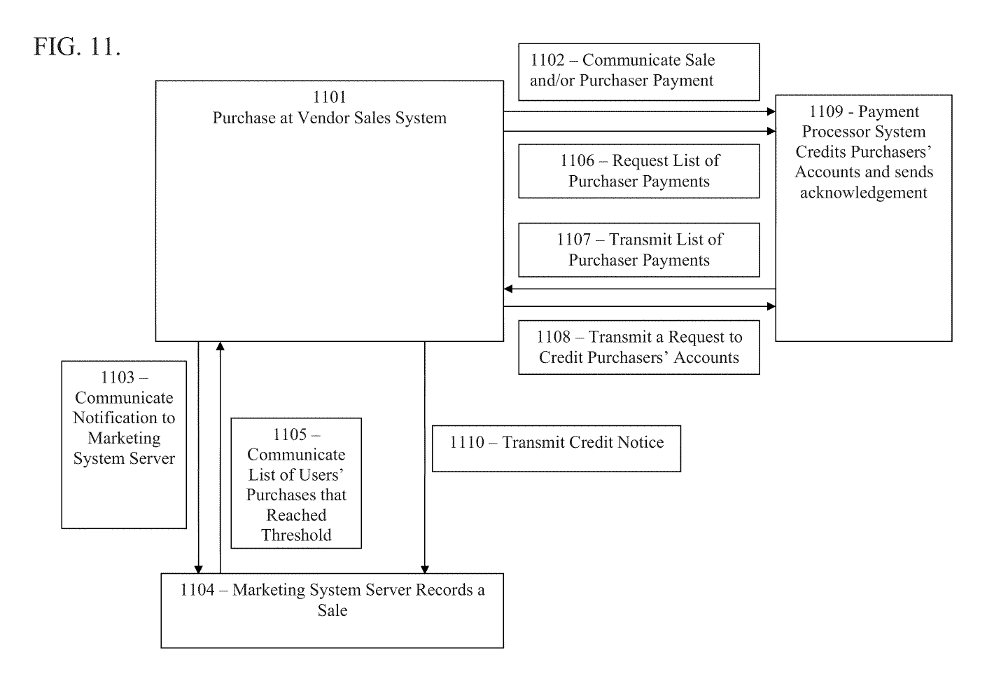

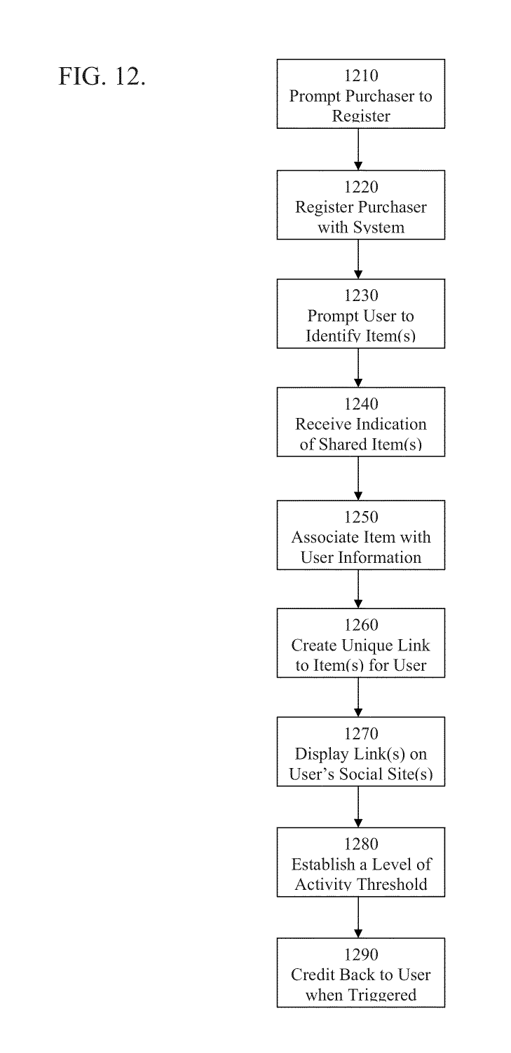

FIGS. 11 and 12 illustrates an example of the communication exchanges between various marketing system components, vendor sales systems, and payment processors for providing a reward to a user. The exchange begins at 1101 with a purchase at a vendor sales system, where the sales system can be a physical point-of-sale system or an online server system. Payment by the purchaser is submitted to the particular payment processor 1102 for authorization of the payment and recording of the transaction. The vendor sales system notifies the marketing system application server 1103 that a qualifying sales has occurred through the Share API. The marketing system application server records the sale 1104 and increments the correct tracking field. The marketing system server sends a list of users' purchases that have reached the threshold necessary to receive a reward to the vendor sales system 1105. The vendor sales system identifies the purchasers' accounts that are entitled to a reward based on the list communicated from the marketing system, and transmits a request to the payment processor to provide a list of the payments made by the purchasers through the payment processor 1106. The payment processor provides a list of the transactions and/or payment to the vendor sales system 1107. The vendor sales system transmits a request to credit the identified purchasers' accounts the calculated amount of reward 1108. The payment processor credits the purchaser's account the amount of refund indicated by the vendor, and sends an acknowledgement to the vendor 1109 that the crediting of the account has been completed. The vendor sales system transmits the completed credit notice to the marketing system server 1110, so it can update the purchaser's/user's share account.

FIG. 12 depicts an exemplary sequence of steps implemented to receive information at a marketing system server where information received from different sources identifies a vendor, one or more purchased item, a purchaser, a purchasers social networking sites, and a level of activity from a link associated with a purchased item. The marketing system can use the received information to identify a purchase on a vendor's sales system, create a unique URL for a purchased item, push the URL link to the user's social networking sites, create a record of the user, log the amount activity generated by the URL, determine when the generated activity level reaches a threshold level, and trigger a credit back to a user of a portion of an item's purchase price.

When a qualifying sale is made through a vendor sales system in communication with the marketing system, the marketing system is alerted through an API that the sale has been made. At step 1210, the marketing system asks the purchaser conducting a transaction at the vendor's sales system if they wish to register as a user with the marketing system through an electronic prompt communicated from the marketing system server to the vendor's sales system or purchaser's device, which could be displayed as an entry form on a point-of-sale display, a web page running scripts, a pop-up window on the vendor's website, or other interfaces known in the art. If a purchaser elects to register with the system, the marketing system will request that they provide personal information to register. In some embodiments, the marketing system will send a request for information with the registration prompt. At step 1220, when the marketing system receives personal information from a purchaser, the system will use the information to create a new record for the purchaser, so they are registered with the marketing system. At step 1230, the marketing system recognizes that a purchaser has conducted a transaction at a vendor's sales system and prompts the user to identify any purchased items they would want to display on their social network(s). This can be done through a list displayed to the purchaser on the vendor's system or website. The marketing system receives a response comprising a selection or a rejection by the purchaser. At Step 1240, the marketing system receives a response comprising a selection or a rejection by the purchaser. At step 1250, the marketing system associated a selected item with the purchaser and the vendor's internal order number, and stores the information in fields of the registered purchaser's marketing system record. At step 1260, the information received from the purchaser and vendor are used by the marketing system to create a unique URL link to the item that will be used by the marketing system to track online activity relating to the particular user and item. At step 1270, the link with the unique URL is pushed onto the user's social network sites along with image(s) and commentary, so the product information is displayed, through hooks and APIs with the networking sites, as is known to those in the art. At step 1280, the marketing system establishes the amount of marketing activity that must be generated through the unique link to qualify the registered user to receive a credit back on the initial purchase. At step 1290, the system provides a credit back to the purchaser when the amount of activity through the unique link has reached the pre-established threshold level. The credit can be applied to the user's credit card for a portion of the initial purchase price through an API of a payment processor, or a portion of the initial purchase price can be donated to a charity of the user's choice. Other possible reimbursements to the user include providing the user with a voucher for free services, the system giving the user value-added services, as well as forwarding the amount of the credit to a third party such as a gift to a friend or charity.

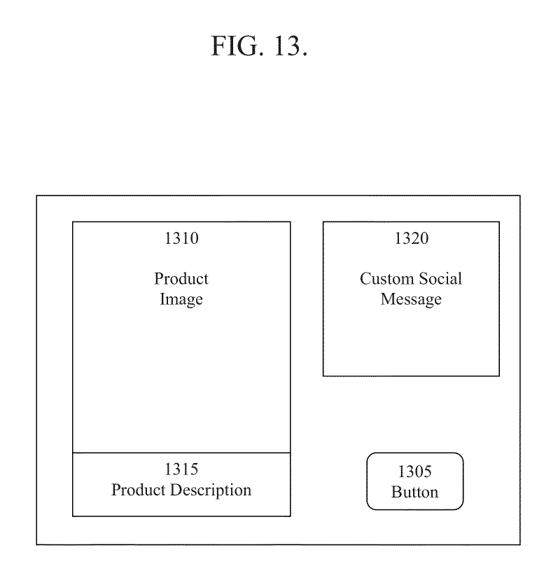

FIG. 13 shows an example of a button 1305 and associated product image 1310 and commentary 1315 hooked into a user's social network site and displayed on the user's network page. The unique URL is embedded in the button 1305 associated with the image and commentary as a link to allow tracking of social interest in the displayed product. The user's social message 1320 can also be displayed along with the image and button.

It is to be understood that some or all of the above described features, components and method steps can be combined in different ways and sequences, and variations and modifications other than those illustrated will be apparent to persons of ordinary skill in the art. In particular, various embodiments of the invention may be implemented with other choices of communications and computer hardware and software, according to the criteria stated above. Each and every such possible permutation and combination is separately deemed to be an embodiment herein in its own right. The illustrative examples are merely representative. It is therefore intended that all of these embodiments, examples, variations and modifications thereon are meant to be encompassed within the spirit and scope of the present invention as set forth in the following claims.

Potential social-network marketers are prompted to register with the marketing system when they make a purchase online through ecommerce portals, in a store at a point-of-sale system, or through a mobile device.

A purchaser registers as a marketing system user by providing personal information that is used to identify the system user and prepare a record in which the user's purchases will be stored and offered to the system user as a list from which shared items can be selected.

Although this present invention has been described in considerable detail with reference to certain preferred versions thereof, other embodiments are possible. Therefore, the spirit and scope of the invention should not be limited to the description of the preferred embodiments contained herein. In addition, the examples provided each describe a particular number of steps, however, more or less steps and variations of the above described order are also contemplated, and should be considered within the principles and scope of the invention.

Those of ordinary skill would further appreciate that the various illustrative logical blocks, modules, circuits, and algorithm steps described in connection with the embodiments disclosed herein may be implemented as electronic hardware, computer software, or combinations of both.

The various illustrative logical blocks, modules, processes and functions described in connection with the embodiments disclosed herein may be implemented or performed with a general purpose processor (e.g., such as one in a computer or server), or with some other type of processor.

In one or more exemplary embodiments, the functions described may be implemented in hardware, software, firmware, or any combination thereof. If implemented in software, the functions may be stored on or transmitted over as one or more instructions or code on a computer-readable medium such as non-transitory computer readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes Compact Disc (CD), laser disc, optical disc, Digital Versatile Disc (DVD), floppy disk and blu-ray disc where disks usually reproduce data magnetically, while discs reproduce data optically with lasers. Combinations of the above should also be included within the scope of computer-readable media.

It should be understood by those of ordinary skill in the art of computers and telecommunications that the communications illustratively described herein typically include forming messages, packets, or other electronic signals that carry data, commands, or signals, to recipients for storage, processing, and interaction. It should also be understood that such information is received and stored, such as in a database, using electronic fields and data stored in those fields.

It is to be understood that some or all of the above described features, components and method steps can be executed in different orders, combined in different ways, and implement other variations and modifications other than those illustrated that will be apparent to persons of ordinary skill in the art. In particular, the various embodiments of the present invention may be implemented with other choices of hardware, and software distributed over the different hardware components or within a computing cloud, as well as the storage and processing of the data, according to the embodiments and criteria stated above. Each and every one of these permutations and combinations is separately deemed to be an embodiment herein in its own right, and engineering requirements and/or governing code appropriate for transmission and communication between the components, as well as the implementation of the application(s), will govern the use and deployment of the said embodiments and establish separate embodiments herein such that each and every one is its own embodiment. It is therefore intended that all of these embodiments, examples, variations and modifications thereon are meant to be encompassed within the spirit and scope of the present invention as set forth in the following claims.

What is claimed is:

1. A computer-implemented method of incentivizing word-of-mouth marketing through social networks, which comprises:
prompting a purchaser to register as a social-network system user;
registering a purchaser as a network marketing system user;
prompting the marketing system user to identify which purchased item(s) will be shared through their social networks;
receiving an indication of which purchased item(s) will be shared;
creating a link with a unique URL address related to each of the shared item(s), wherein the URL address associates the system user with the shared item(s);
displaying the link(s) on the system user's social networking sites, wherein the link allows third-parties to click on the link and be redirected to a different website, and wherein the word-of-mouth marketing activity can be tracked through the unique URL address;
establishing a threshold level of marketing activity for compensating the system user for their word-of-mouth social network marketing; and
crediting a portion of the system user's original purchase price back to the user when the threshold level of activity through the unique URL has been reached.

2. The method of claim 1, which further comprises:
sending a request to the purchaser to provide personal identifying information for registration, identification of social networks the purchaser is a member of;
receiving the marketing system user's personal identifying information;
storing the marketing system user's personal identifying information and identified social networks on the network marketing system; and
associating the identified purchase items with the user's personal identification information, and storing product information for the identified purchased item on the marketing system; and
placing identified purchase items in a gallery on the user's social network that can be browsed by third-parties.

3. The method of claim 1, wherein the activity of the word-of-mouth marketing is tracked based upon the number of clicks on the unique link related to the item, the amount of comments generated related to the item, the number of Likes related to the item, and the number of re-tweets incorporating the unique URL related to the item.

4. The method of claim 1, which further comprises valuing the extent of marketing by a system user by determining the number of different third parties clicking through the unique URL by placing cookies on each parties system when they are redirected to the marketing system;
storing, on the network marketing system, the cost of the item being shared; and
calculating a weighted value for the marketing activity based upon the cost of the item and the actual extent of the word-of-mouth marketing activity, wherein the weighted value is used to determine if the established threshold level has been reached.

5. The method of claim 1, wherein the portion of the purchase price credited back to the user is applied to the user's original form of payment, and wherein the portion credited back is a predetermined percentage of the original price of the shared item.

6. A computer-implemented method of valuing word-of-mouth marketing through social networks, which comprises:
registering an individual with a word-of-mouth marketing system as a marketing system user;
creating an account for a registered marketing system user;
requesting the registered marketing system user to identify the social networks with whom they have an account;
storing a list of identified social networks in a database;
creating a link with a unique URL address associated with the user,
providing the link to the user;
importing the registered marketing system user's social network connections from the identified social networks, wherein the social network connections are members of the user's social network;
determining the number of third-party members a registered marketing system user has in their social connections;
storing the user's social connections in a computer system's memory;
mapping the relationships between the user's imported social connections to form a linked set of nodes for tracking the propagation of a social referral through the user's social connections, wherein a node represents one members of the user's social network.

7. The method of claim 6, which further comprises:
identifying the type of social referral propagated between the linked nodes of the map, wherein the referral type can be a comment, a Like, a forwarded link with the unique URL, or a re-tweet with the URL;
tracking the number of referrals passed between nodes of the map;
tracking the number of times the link with the unique URL is clicked by a member of the user's social network;
determining a relative weight factor for each type of referral and each click on the URL;
calculating a total weighted value representing the amount of social activity that is generated by the market system user.

8. The method of claim 7, wherein the weighted value is calculated by summing the number of referrals of each type multiplied by their weight factor with the number of clicks by members of the user's social network.

9. The method of claim 7, which further comprises:
placing a tracking cookie on each device of each member of the user's social network that is utilized to click on the link, and track the distribution of exposure through the user's social network;
mapping the progression of shares through the marketing system user's social networks to determine the propensity of the user's network connections to rebroadcast the user's initial sharing of a purchased item; and
utilizing the extent of rebroadcasting for a particular item to identify higher valued networks.

10. The method of claim 7, which further comprises:
determining the value of the system user's network to the marketing system from the size of the identified social network(s), wherein the size is based on the number of connections, and the amount of influence the system user has over the connections, as indicated by the percentage of connections that purchased a previously shared item, to determine the probability that a number of sales shall be made through sharing on the user's network; and
informing the vendor to retroactively credit a portion of the system user's original purchase price back to the user's original payment form based upon the actual number of sales or amount of activity meeting or exceeding the determined value.

11. A computer system for promoting word-of-mouth marketing over social networks, which comprises:
a server system comprising non-transient computer readable storage and at least one processor for running at least an application program and a database program;
an application program running on the server system, wherein the application program comprises:
a communication function that is configured to connect a vendor's sales system to a word-of-mouth marketing system server over a communication network;
an interface function communicating between the vendor's sales system and the marketing server system, wherein the interface is configured to allow the marketing server system to prompt a purchaser interacting with the vendor's sales system to create an account with the marketing server system, identify one or more social network(s) with which the purchaser has an account, and select one or more items to be shared on the identified social networks from a set of one or more item(s) purchased by the purchaser at a particular sales price;
a URL assignment function that is configured to create a new, unique URL, wherein the URL relates the item to be shared with the registered user;
a database program running on the server system that is configured to store information relating to at least a specific user's identification information, a set of social connections, a set of purchased items, and product information for a purchased item selected to be shared on a social network;
a cookie tracking function running on the server system that is configured to place a tracking cookie on a third-party's electronic device when the third party clicks on the unique URL relating to the shared item; and
a monitoring function running on the server system that is configured to monitor the number of times the third party clicks on the URL for the shared item or determine if another third party has accessed a shared item through a secondary referral.

12. The computer system of claim 11, which further comprises a reward function that establishes a threshold value for the number of times a shared item has been accessed through a link having the assigned unique URL or accessed through a secondary referral as indicated by the tracking cookies placed on third-party devices, and communicates to the vendor's sales system instruction to credit back to the purchaser a portion of the particular sales price when the established threshold has been exceeded.

13. The computer system of claim 11, which further comprises:
a social network tracking function configured to monitor the marketing system user's purchases of items to determine the frequency of the user's purchases, the quantity of items purchased, and the amount spent on each purchase;
store the frequency, quantity, and mount of each purchase made, and the specific product(s) purchased by the particular system user in the database file for the specific system user, identifying the type(s) of products that the system user purchases, wherein the product types are predetermined categories defined by the marketing system;
identify the amount spent on products in each category, and determine the probability that the marketer will purchase another item within the same categories as previously purchased items from a different vendor.

14. The computer system of claim 11, wherein the user interface through is configured to provide a button for a purchaser to click to create a new account, one or more fields for the purchaser to enter their specific identification information, a predetermined list of social networks from which the purchaser can select one or more social networks, and a button for the purchaser to click to select one or more purchased item for sharing on the one or more selected social websites.

15. The computer system of claim 15, which further comprises assigning a value to the one or more shared item(s), wherein the value is calculated using the probability that a third party will eventually purchase the shared item and the price of the shared item.

16. A system for stimulating the word-of-mouth marketing effort, which comprises:
a computer system running one or more applications, wherein the computer system is configured to connect to one or more vendor's sale system, create an account for a user who completes a purchase through a connected vendor's sales system, store information on the system about items selected by the user from the set of items purchased through the sales system purchases, post the one or more selected items on the user's selected social networks with a unique URL link for each item that is capable of redirecting a third party to the computer system, measure the amount of activity on the user's social network related to the selected item(s), and reward the user for sharing the selected item with others on the user's social network by crediting an amount of the selected item's purchase price back to the user when the measured activity reaches or exceeds a predetermined amount.

17. The computer system of claim 16, wherein a sales system can be an in-store point-of-sale system, an online ecommerce portal, and/or a mobile device application portal, the selected item is placed in an image gallery on the social network(s) that can be browsed by third-parties, and wherein the user can add textual comments regarding the selected item(s) to the post on the social network(s).

18. The computer system of claim 17, wherein the amount of activity on the user's social network comprises click-throughs on the item link, comments, Likes, +1s, Responses, and Retweets, and wherein the user receives credit applied to the original form of payment used to purchase the selected item.

19. A non-transitory computer readable storage medium having computer-readable instructions executable by a computer processing system stored thereon, the computer-readable instructions comprising:
instructions that cause a computer system to register a person as a word-of-mouth marketer,
instructions that cause the computer system to store information personal to the marketer on the system;
instructions that cause the computer system to request the marketer to identify one or more social networks with whom the marketer has an active account;
instructions that cause the computer system to store a list of items purchased by the marketer for future selection by the marketer for the selected item to be shared;
instructions that cause the computer system to request the marketer to select one or more items to be shared over the marketer's identified social networks from a list of purchased item;
instructions that cause the computer system to share the selected item(s) over the marketer's identified social networks; and
instructions that cause the computer system to monitor the amount of activity resulting from the sharing of the selected item(s) on the marketer's social network(s); and
instructions that cause the computer system to reward a marketer by informing a vendor that a portion of a purchase price to the item should be retroactively credited back to the marketer.

20. The non-transitory computer readable storage medium of claim 19, which further comprises:
instructions that cause the computer system to import a list of social connection from the one or more social network(s) identified by the marketer;
instruction that cause the computer system to calculate a value for the marketer's imported social connection(s) using the number of social connections and the amount of activity on the social network relating to the shared item.
